(19) United States
(12) Patent Application Publication
(10) Pub. No.: US 2005/0089145 A1
(43) Pub. Date: Apr. 28, 2005

(54) Systems and methods for reducing radiation dosage

(76) Inventors: Steven Gerard Ross, Waukesha, WI (US); Thomas Louis Toth, Brookfield, WI (US); Willi Walter Hampel, Hartland, WI (US); Bruce Matthew Dunham, Mequon, WI (US)

Correspondence Address: Patrick W. Rasche;Armstrong Teasdale LLP, Suite 2600, One Metropolitan Square, St. Louis, MO, 63102, US

(21) Appl. No.: 10/695,211

(22) Filed: Oct. 28, 2003

(51) Int. Cl. G21K 1/02

(52) U.S. Cl. 378/147

(57) ABSTRACT

An imaging system including is described. The imaging system includes a radiation source configured to generate a beam, a collimator configured to collimate the beam to generate a collimated beam, and a detector configured to detect the collimated beam. The collimator is one of a first collimator with a curved contour proportional to a contour of the detector, a second collimator with blades, where slopes of two oppositely-facing surfaces of at least one of the blades are different from each other, and a third collimator having at least two sets of plates, where the plates in a set pivot with respect to each other.

### BACKGROUND OF THE INVENTION

This invention relates generally to imaging systems and more particularly to systems and methods for reducing radiation dosage incident on a subject.

A third generation computed tomography (CT) scanner includes an x-ray source and a detector that are rotated together around a patient. An x-ray beam is passed through the patient and intensity of the x-ray beam is measured on the detector. In some CT imaging systems, an x-ray tube is used to create the x-rays. X-rays are produced when electrons are accelerated against a focal spot or an anode by a high voltage difference between the anode and a cathode of the x-ray tube. These x-rays typically diverge conically from the focal spot, and the diverging x-ray beam is typically passed through a pre-patient collimator to define an x-ray beam profile on the detector. Some CT imaging systems include detector cells arranged on an arc of constant radius from the source. If the collimator is linear, or rectangular, an x-ray beam profile on the detector will become curved along a fan of the detector as an aperture of the collimator is opened along a z-axis. The curvature can result in both unused x-ray dose and degradation in a CT image formed from the curved x-ray beam profile.

### BRIEF DESCRIPTION OF THE INVENTION

In one aspect, an imaging system is provided. The imaging system includes a radiation source configured to generate a beam, a collimator configured to collimate the beam to generate a collimated beam, and a detector configured to detect the collimated beam. The collimator is one of a first collimator with a curved contour proportional to a contour of the detector, a second collimator with blades, where slopes of two oppositely-facing surfaces of at least one of the blades are different from each other, and a third collimator having at least two sets of plates, where the plates in a set pivot with respect to each other.

In another aspect, a computed tomography imaging system is provided. The computed tomography imaging system includes an x-ray source configured to generate a beam, a collimator configured to collimate the x-ray beam to generate a collimated x-ray beam, and a detector configured to detect the collimated x-ray beam. The collimator is one of a first collimator with a curved contour proportional to a contour of the detector, a second collimator with blades, where slopes of two oppositely-facing surfaces of at least one of the blades are different from each other, and a third collimator having at least two sets of plates, where the plates in a set pivot with respect to each other.

In yet another aspect, a method for reducing dosage of radiation incident on a subject is provided. The method includes transmitting a beam of radiation toward the subject, collimating the beam of radiation before the beam reaches the subject, and detecting the collimated beam of radiation. The collimating is performed by one of a first collimator with a curved contour proportional to a contour of a detector that detects the collimated beam, a second collimator with blades, where slopes of two oppositely-facing surfaces of at least one of the blades are different from each other, and a third collimator having at least two sets of plates, where the plates in a set pivot with respect to each other.

### BRIEF DESCRIPTION OF THE DRAWINGS

FIG. 1 is a perspective view of an embodiment of a computed tomography (CT) imaging system in which systems and methods for reducing radiation dosage are implemented.

FIG. 2 is a block diagram of the CT imaging system of FIG. 1.

FIG. 3 is a diagram of an embodiment of a collimator and a portion of the CT imaging system.

FIG. 4 is a diagram showing embodiments of various types of collimators that can be implemented in the CT imaging system and effects of implementing the different types of collimators.

FIG. 5 is a diagram showing an embodiment of a system for reducing radiation dosage and showing effects of the system.

FIG. 6 is a diagram of an embodiment of a collimator that is used in the CT imaging system of FIG. 1.

FIG. 7 is a diagram of an embodiment of a collimator that is used in the CT imaging system of FIG. 1.

### DETAILED DESCRIPTION OF THE INVENTION

In some known CT imaging system configurations, an x-ray source projects a fan-shaped beam which is collimated to lie within an X-Y plane of a Cartesian coordinate system and generally referred to as an “imaging plane”. The x-ray beam passes through an object, such as a patient, being imaged. The beam, after being attenuated by the object, impinges upon an array of radiation detectors. The intensity of the attenuated radiation beam received at the detector array is dependent upon the attenuation of an x-ray beam by the object. Each detector element of the array produces a separate electrical signal that is a measurement of the beam attenuation at the detector location. The attenuation measurements from all the detectors are acquired separately to produce a transmission profile.

In third generation CT imaging systems, the x-ray source and the detector array are rotated with a gantry within the imaging plane and around the object to be imaged such that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles, or view angles, during one revolution of the x-ray source and detector.

In an axial scan, the projection data is processed to construct an image that corresponds to a two dimensional slice taken through the object. One method for reconstructing an image from a set of projection data is referred to in the art as the filtered back projection technique. This process converts the attenuation measurements from a scan into integers called “CT numbers” or “Hounsfield units”, which are used to control the brightness of a corresponding pixel on a cathode ray tube display.

To reduce the total scan time, a “helical” scan may be performed. To perform a “helical” scan, the object is moved while the data for the prescribed number of slices is acquired. Such a system generates a single helix from a one fan beam helical scan. The helix mapped out by the fan beam yields projection data from which images in each prescribed slice may be reconstructed.

Reconstruction algorithms for helical scanning typically use helical weighing algorithms that weight the collected data as a function of view angle and detector channel index. Specifically, prior to a filtered backprojection process, the data is weighted according to a helical weighing factor, which is a function of both the gantry angle and detector angle. The helical weighting algorithms also scale the data according to a scaling factor, which is a function of the distance between the x-ray source and the object. The weighted and scaled data is then processed to generate CT numbers and to construct an image that corresponds to a two dimensional slice taken through the object.

As used herein, an element or step recited in the singular and preceded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Also as used herein, the phrase “reconstructing an image” is not intended to exclude embodiments of the present invention in which data representing an image is generated but a viewable image is not. However, many embodiments generate (or are configured to generate) at least one viewable image.

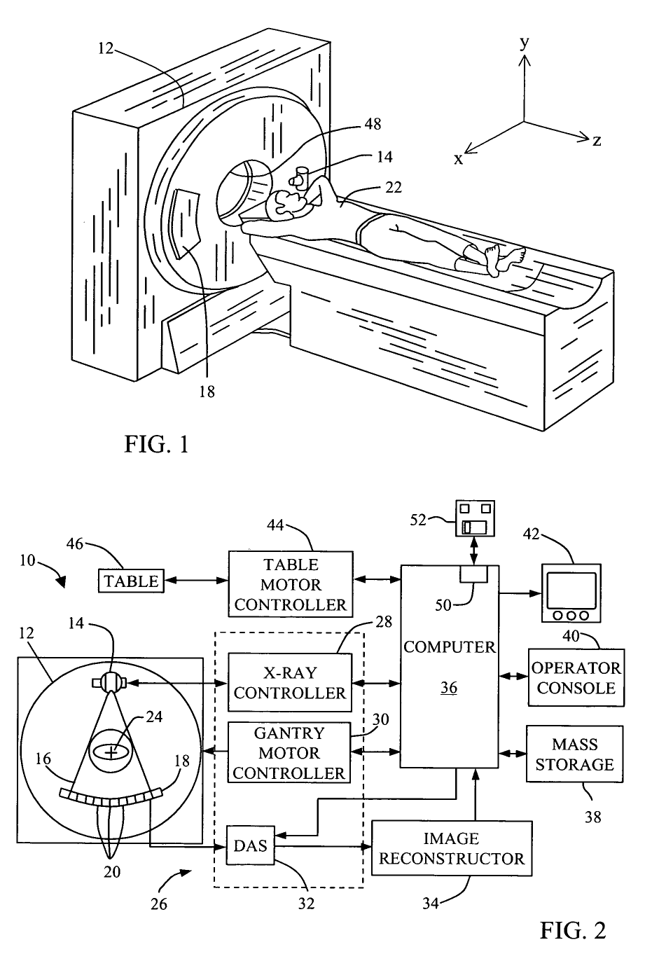

Referring to FIGS. 1 and 2, a multi-slice scanning imaging system, for example, a computed tomography (CT) imaging system 10, is shown as including a gantry 12 representative of a “third generation” CT imaging system. Gantry 12 has an x-ray source 14 that projects a beam of x-rays 16 toward a detector array 18 on the opposite side of gantry 12. Detector array 18 is formed by a plurality of detector rows (not shown) including a plurality of detector elements or cells 20 which together sense the projected x-rays that pass through an object 22, such as a medical patient. As an example, width of each detector element 20 along a z-axis is greater than 40 millimeters (mm) as scaled to an isocenter of x-ray beam 16. Each detector element 20 produces an electrical signal that represents the intensity of an impinging x-ray and hence the attenuation of the x-ray as it passes through object 22. During a scan to acquire x-ray projection data, gantry 12 and the components mounted thereon rotate about a center of rotation 24. FIG. 2 shows only a single row of detector elements 20 (i.e., a detector row). However, multislice detector array 18 includes a plurality of parallel detector rows of detector elements 20 such that projection data corresponding to a plurality of quasi-parallel or parallel slices can be acquired simultaneously during a scan.

Rotation of gantry 12 and the operation of x-ray source 14 are governed by a control mechanism 26 of CT imaging system 10. Control mechanism 26 includes an x-ray controller 28 that provides power and timing signals to x-ray source 14 and a gantry motor controller 30 that controls the rotational speed and position of gantry 12. A data acquisition system (DAS) 32 in control mechanism 26 samples analog data from detector elements 20 and converts the data to digital signals for subsequent processing. An image reconstructor 34 receives sampled and digitized x-ray data from DAS 32 and performs high-speed image reconstruction. The reconstructed image is applied as an input to a computer 36 which stores the image in a mass storage device 38.

Computer 36 also receives commands and scanning parameters from an operator via console 40 that has a keyboard. An associated cathode ray tube display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position object 22 in gantry 12. Particularly, table 46 moves portions of object 22 through gantry opening 48.

In one embodiment, computer 36 includes a device 50, for example, a floppy disk drive, CD-ROM drive, DVD drive, magnetic optical disk (MOD) device, or any other digital device including a network connecting device such as an Ethernet device for reading instructions and/or data from a computer-readable medium 52, such as a floppy disk, a CD-ROM, a DVD or an other digital source such as a network or the Internet, as well as yet to be developed digital means. In another embodiment, computer 36 executes instructions stored in firmware (not shown). Computer 36 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

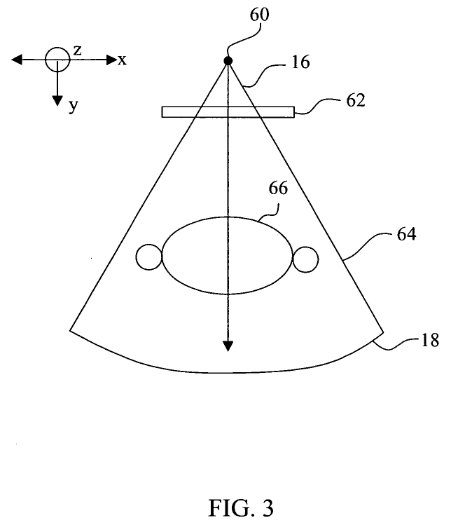

FIG. 3 is a diagram of an embodiment of a pre-patient collimator 62 and a portion of gantry 12 of CT imaging system 10. X-ray beam 16 emanates from a focal point 60 at which x-ray source 14 is located. X-ray beam 16 is collimated by collimator 62, and a collimated fan beam 64 is projected via an object 66 toward detector array 18 along a fan beam axis centered within collimated beam 64. Detector array 18 is curved at a fixed radius from focal point 60.

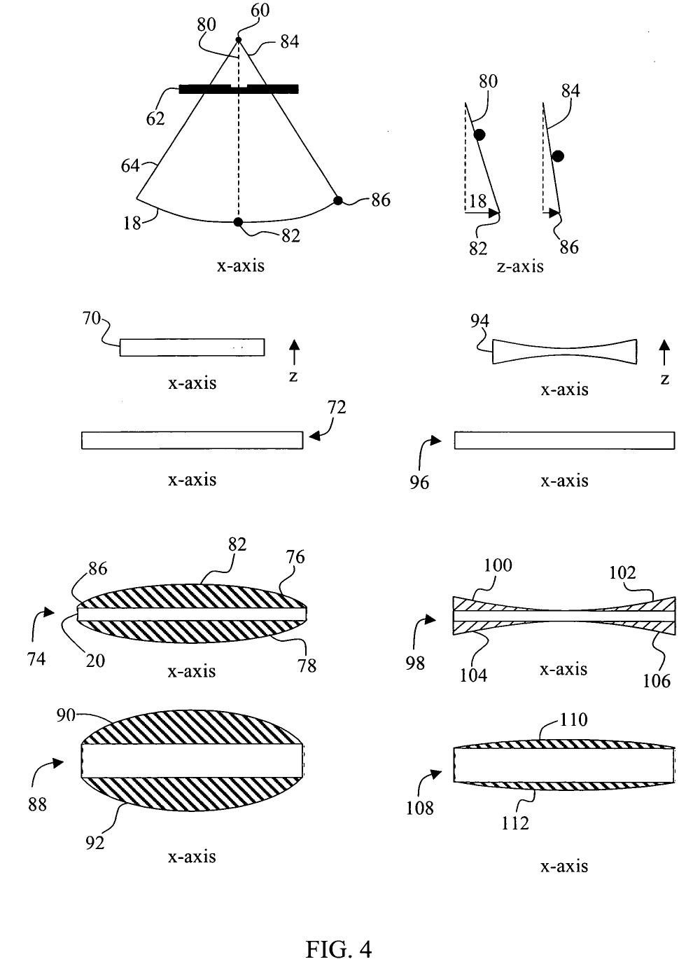

FIG. 4 is a diagram showing embodiments of various types of collimators that can be implemented in CT imaging system 10 and showing effects of implementing the different types of collimators. If collimator 62 produces a linear or a rectangular aperture 70 of a small size, such as a width along the z-axis, the projection of collimated beam 64 forms an x-ray beam profile 72 on detector array 18. If width of aperture 70 of collimator 62 is increased along the z-axis, x-ray beam profile 72 develops a convex curve along an x-axis to generate an x-ray beam profile 74. Each x-ray in collimated beam 64 impinges upon detector elements 20 in detector array 18 at a z-axis location. However, since detector elements 20 are usually rectangular, shaded portions 76 an 78 of x-ray beam profile 74 do not impinge on detector elements 20. Hence, object 66 is unnecessarily exposed to x-ray beam 16 that resulted in unused portions 76 and 78.

Furthermore, portions 76 and 78 may also generate artifacts on an image reconstructed from x-ray beam profile 74. A distance 80 between focal point 60 and collimator 62 corresponds to a point 82 on x-ray beam profile 74 and a distance 84 between focal point 60 and collimator 62 corresponds to a point 86 on x-ray beam profile 74. Distance 80 is shorter than distance 84 as a result of which the artifacts are created. Moreover, as width of aperture 70 of collimator 62 is further increased along the z-axis, an x-ray beam profile 88 is formed with shaded portions 90 and 92 that introduce a higher amount of artifacts than those introduced by x-ray beam profile 74.

When collimator 62 includes a tapered or a sloped aperture 94 with a slope, for instance, along the x-axis, the projection of collimated beam 64 forms an x-ray beam profile 96 on detector array 18. The taper of aperture 94 is set so that x-ray beam profile 96 is rectangular for a pre-determined size, such as a width along the z-axis, of aperture 94. Moreover, the taper of aperture 94 can be varied to optimize the taper for various sizes of aperture 94. However, it is difficult to manufacture aperture 94 having a variable taper because a level of smoothness of surfaces of aperture 94 cannot be achieved easily. If an x-ray beam profile 98 is generated by collimating x-ray beam 16 with collimator 62 not having the level of smoothness, x-ray beam profile 98 includes shaded portions 100, 102, 104, and 106. Portions 100, 102, 104, and 106 introduce artifacts in images generated from x-ray beam profile 98.

Moreover, as size of aperture 94 of collimator 62 is increased, an x-ray beam profile 108 with shaded portions 110 and 112 is generated. Portions 110 and 112 have a larger area than area of portions 100, 102, 104, and 106. Portions 110 and 112 introduce more artifacts in an image generated from x-ray beam profile 108 than artifacts introduced in an image generated from x-ray beam profile 98. The introduction of more artifacts with an increase in the size of aperture of collimator renders it difficult to provide an adequate range of sizes of aperture 94 of collimator 62. Furthermore, as size of apertures 70 and 94 is increased, the mass of collimator 62 used to absorb x-ray beam 16 becomes excessive.

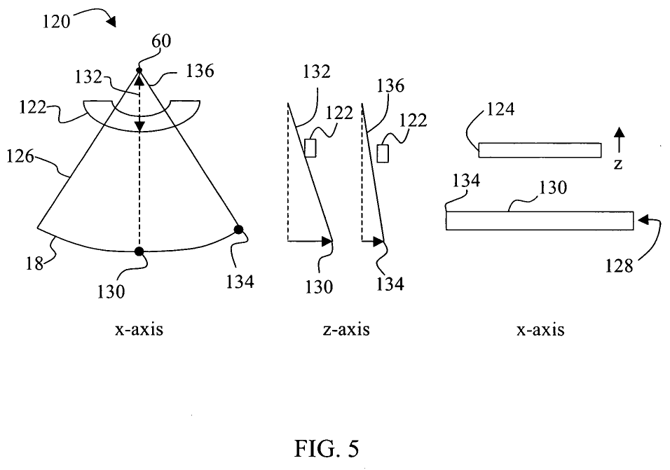

FIG. 5 shows an embodiment of a system 120 for reducing radiation dosage. System 120 includes x-ray source 14 at focal point 60, a collimator 122, and detector array 18. Collimator 122 is contoured in a direction along a y-axis. Collimator 122 includes cams that are driven linearly along the z-axis to produce apertures of various sizes, such as widths. Aperture 124 is an example of an aperture formed by the cams of collimator 122. Prior to scanning, the cams are driven to a pre-set position by a linear drive mechanism, such as a screw, to form a pre-set aperture between the cams. To change a size of the pre-set aperture during a scan, a piezo-electric drive mechanism is used to position the cams.

X-ray source 14 transmits x-ray beam 16 towards collimator 122. Collimator 122 collimates or restricts x-ray beam 16 to generate a collimated beam 126. Collimated beam 126 falls on detector elements 20 and generates an x-ray beam profile 128. X-ray beam profile 128 is a projection of collimated beam 126. Curvature of x-ray beam profile 128 is minimal for all sizes, such as widths, of apertures formed by the cams of collimator 122.

A radius of curvature of collimator 122 is proportional to a radius of curvature of detector array 18. As an example, a radius of curvature of detector array 18 at a point 130 is x+y centimeters (cm), where x is a radius of curvature of collimator 122 at a distance 132 from focal point 60, and where x and y are real numbers greater than zero. In this example, a radius of curvature of detector array 18 at a point 134 is m+y cm, where m is a radius of curvature of collimator 122 at a distance 136 from focal point 60, and where m is a real number greater than zero. A radius of curvature of collimator 122 and detector array 18 is measured from focal point 60. Unlike distances 80 and 84, distance 132 is approximately equal to distance 136 because a contour of collimator 122 matches a contour of detector array 18.

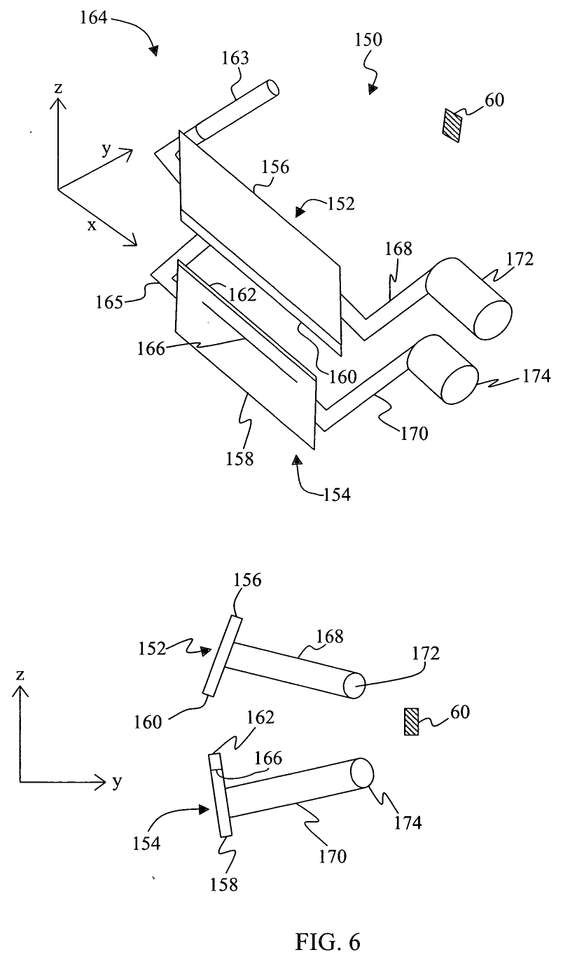

FIG. 6 shows an embodiment of a collimator 150 that is used in systems and methods for radiation dosage. Collimator 150 includes blades or plates 152 and 154. Blades 152 and 154 can be of shapes such as square, rectangular, polygonal, circular, and oval. Each blade 152 and 154 has a respective outer surface 156 and 158 and a respective inner surface 160 and 162. Inner surface 160 of blade 152 has different taper or slope than outer surface 156 and inner surface 162 of blade 154 has a different taper than outer surface 158. In an alternative embodiment, any one of surfaces 156, 158, 160, and 162 has a different taper than remaining surfaces. Blades 152 and 154 may be of the same or different sizes. A pivot arm 163 supports blade 152 and a pivot arm 165 supports blade 154.

Blades 152 and 154 are partially closed but do not overlap each other, as shown in an isometric view 164, to form an aperture with a large width between inner surfaces 160 and 162 of blades 152 and 154. An example of an aperture with a large width is an aperture whose x-ray beam profile has a width greater than 30 mm on detector array 18. When blades 152 and 154 are partially closed to obtain the aperture with the large width, distance between outer surfaces 156 and 158 is greater than distance between inner surfaces 160 and 162. Tapers of inner surfaces 160 and 162 can be optimized for apertures of large widths.

Alternatively, blades 152 and 154 are partially closed but do not overlap each other to form an aperture with a medium width between outer surfaces 156 and 158 of the blades. If blades 152 and 154 are in a position shown in isometric view 164, the blades are overlapped with each other and cross-over each other so that an aperture with a medium width is formed between outer surfaces 156 and 158 of the blades. An example of an aperture with a medium width is an aperture whose x-ray beam profile has a width from 1 mm to 30 mm on detector array 18. When blades 152 and 154 are partially closed to obtain the aperture with the medium width, distance between inner surfaces 160 and 162 is greater than distance between outer surfaces 156 and 158. Tapers of outer surfaces 156 and 158 can be optimized for apertures of medium widths.

In yet another alternative embodiment, blade 154 includes a slit 166 or an aperture having a small width through which x-ray beam 16 passes to form an x-ray beam profile on detector array 18. An example of an aperture with a small width is an aperture whose x-ray beam profile has a width of approximately 1 mm on detector array 18. Alternatively, cam 152 includes slit 166.

Each blade 152 and 154 is coupled to a respective shaft 168 and 170 that is coupled to a respective motor 172 and 174. Motors 172 and 174 provide rotational motion to blades 152 and 154 so that the blades can overlap and cross-over each other. Alternatively, a linear drive mechanism is used to operate blades 152 and 154. However, motors 172 and 174 have less susceptibility to wear and tear as compared to the linear drive mechanism.

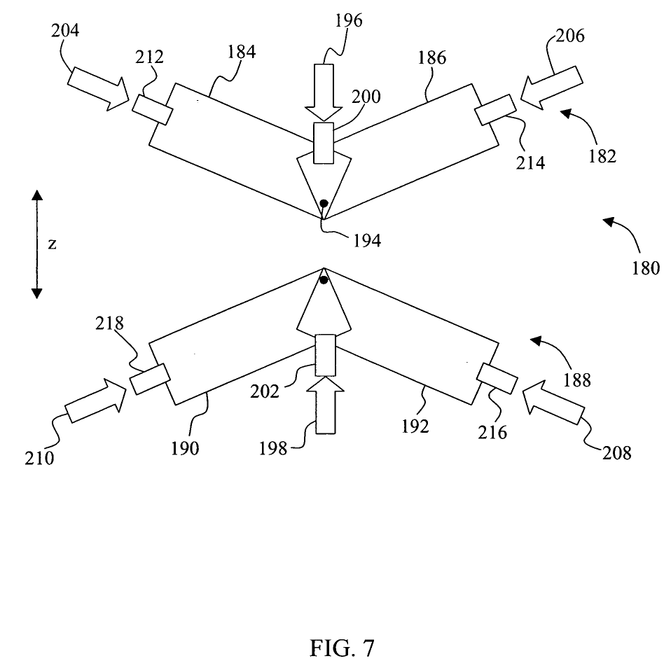

FIG. 7 shows another alternative embodiment of a collimator 180 that is used in systems and methods for reducing radiation dosage. Collimator 180 includes a first set 182 of plates or blades 184 and 186 and a second set 188 of plates or blades 190 and 192. Plates 184 and 186 can be of shapes such as square, rectangular, polygonal, circular, and oval. Plates 184 and 186 are coupled to each other by a hinge 194 so that plates 184 and 186 move with respect to each other. Plates 190 and 192 are coupled in a similar manner to that of plates 184 and 186. Inner drives, which are shown as arrows 196 and 198, and rectangles 200 and 202, control a nominal width, for instance, a width at ends, of an aperture formed between set 182 and set 188. Outer drives, which are shown as arrows 204, 206, 208, and 210, and rectangles 212, 214, 216, and 218, adjust a taper or a slope, for instance, along the z-axis, of the aperture formed between set 182 and set 188. An optimal x-ray beam profile can be generated on detector array 18 for all nominal apertures formed between set 182 and set 188.

Technical effects of the herein described systems and methods include reducing a curvature of an x-ray beam profile formed on detector array 18 while simultaneously supporting a wide range of apertures. For instance, collimator 150 provides apertures of large, medium, and small widths while simultaneously reducing curvature of x-ray beam profiles. It is noted that although CT imaging system 10 described herein is a “third generation” system in which both the x-ray source 14 and detector array 18 rotate with gantry 12, many other CT imaging systems including “fourth generation” systems where a detector is a full-ring stationary detector and an x-ray source rotates with the gantry, may be used. It is also noted that although a curved detector array is shown in FIGS. 1, 2, 3, 4, and 5, a linear or a straight detector array can be used instead. For instance, collimator 150 collimates x-ray beam 16 to project an x-ray beam profile on the linear detector array. As another instance, collimator 180 collimates x-ray beam 16 to project an x-ray beam profile on the linear detector array.

While the invention has been described in terms of various specific embodiments, those skilled in the art will recognize that the invention can be practiced with modification within the spirit and scope of the claims.

1. An imaging system comprising:
a radiation source configured to generate a beam;
a collimator configured to collimate the beam to generate a collimated beam; and
a detector configured to detect the collimated beam, wherein the collimator is one of:
a first collimator with a curved contour proportional to a contour of the detector;
a second collimator with blades, wherein slopes of two oppositely-facing surfaces of at least one of said blades are different from each other; and
a third collimator having at least two sets of plates, wherein said plates in a set pivot with respect to each other.

2. An imaging system in accordance with claim 1 wherein said curved contour of said first collimator and said contour of said detector are concentric.

3. An imaging system in accordance with claim 1 further comprising:
a linear drive mechanism configured to form an aperture of said first collimator, wherein the aperture has a size; and
a piezo-electric drive mechanism configured to change the size of the aperture of said first collimator.

4. An imaging system in accordance with claim 1 wherein said blades of said second collimator are configured to form an aperture having one of a first size, a second size, and a third size, wherein the first size is greater than the second size and the second size is greater than the third size.

5. An imaging system in accordance with claim 4 wherein said blades of said second collimator include outer surfaces tapered to form the aperture of the second size.

6. An imaging system in accordance with claim 4 wherein said blades of said second collimator include inner surfaces tapered to form the aperture of the first size.

7. An imaging system in accordance with claim 1 wherein at least one of said blades of said second collimator include a slit.

8. An imaging system in accordance with claim 1 wherein said plates in each set pivot about a pivot point and wherein each set of plates is configured to be driven by applying a force at said pivot point to change a width of an aperture formed between said sets.

9. An imaging system in accordance with claim 1 wherein each set of plates is configured to be driven by applying a force at edges of each set to change a slope of an aperture formed between said sets.

10. An imaging system in accordance with claim 1 wherein said collimator is located between a subject and said radiation source.

11. A computed tomography imaging system comprising:
an x-ray source configured to generate a beam;
a collimator configured to collimate the x-ray beam to generate a collimated x-ray beam; and
a detector configured to detect the collimated x-ray beam, wherein the collimator is one of:
a first collimator with a curved contour proportional to a contour of the detector;
a second collimator with blades, wherein slopes of two oppositely-facing surfaces of at least one of said blades are different from each other; and
a third collimator having at least two sets of plates, wherein said plates in a set pivot with respect to each other.

12. A computed tomography imaging system in accordance with claim 11 wherein said curved contour of said first collimator and said contour of said detector are concentric.

13. A computed tomography imaging system in accordance with claim 11 further comprising:
a linear drive mechanism configured to form an aperture of said first collimator, wherein said aperture has a size; and
a piezo-electric drive mechanism configured to change the size of said aperture of said first collimator.

14. A computed tomography imaging system in accordance with claim 11 wherein said blades of said second collimator are configured to form an aperture having one of a first size, a second size, and a third size, wherein the first size is greater than the second size and the second size is greater than the third size.

15. A computed tomography imaging system in accordance with claim 14 wherein said blades of said second collimator include outer surfaces tapered to form the aperture of the second size.

16. A computed tomography imaging system in accordance with claim 14 wherein said blades of said second collimator include inner surfaces tapered to form the aperture of the first size.

17. A computed tomography imaging system in accordance with claim 11 wherein at least one of said blades of said second collimator include a slit.

18. A computed tomography imaging system in accordance with claim 11 wherein said plates in each set pivot about a pivot point and wherein each set of plates is configured to be driven by applying a force at said pivot point to change a width of an aperture formed between said sets.

19. A computed tomography imaging system in accordance with claim 11 wherein each set of plates is configured to be driven by applying a force at edges of each set to change a slope of an aperture formed between said sets.

20. A method for reducing dosage of radiation incident on a subject, said method comprising:
transmitting a beam of radiation toward the subject;
collimating the beam of radiation before the beam reaches the subject; and
detecting the collimated beam of radiation, wherein the collimating is performed by one of:
a first collimator with a curved contour proportional to a contour of a detector that detects the collimated beam;
a second collimator with blades, wherein slopes of two oppositely-facing surfaces of at least one of said blades are different from each other; and
a third collimator having at least two sets of plates, wherein said plates in a set pivot with respect to each other.
